(19) United States
(12) Patent Application Publication
(10) Pub. No.: US 2026/0299823 A1
(43) Pub. Date: Oct. 1, 2026

(54) OPERATION CONTROL METHOD AND APPARATUS

(71) Applicant: Smarter Silicon (Shanghai) Technologies Co., Ltd., Shanghai (CN)

(72) Inventor: Zhihao DONG, Shanghai (CN)

(21) Appl. No.: 19/633,475

(22) Filed: Mar. 30, 2026

(30) Foreign Application Priority Data
Mar. 31, 2025 (CN) 202510399278.9

(51) Int. Cl. G06F 3/06

(52) U.S. Cl. CPC G06F 3/0655; G06F 3/0604; G06F 3/0679

(57) ABSTRACT

An operation control method includes determining a first processing unit for executing an operation sequence including operation(s) to be executed for processing an inference task based on an artificial intelligence model, and if the operation sequence includes a target operation depending on weight data and before the first processing unit obtains target weight data associated with the target operation, scheduling a second processing unit to read the target weight data from a first memory and storing it into a second memory. The first and second processing units are connected to the second memory. Data bandwidths between the second memory and the first and second processing units are greater than a data bandwidth between the second memory and the first memory. The method further includes, during a process of the first processing unit executing the operation sequence, reading the target weight data from the second memory based on the target operation.

### CROSS-REFERENCES TO RELATED APPLICATION

The present disclosure claims priority to Chinese Patent Application No. 202510399278.9, filed on Mar. 31, 2025, the entire content of which is incorporated herein by reference.

### FIELD OF TECHNOLOGY

The present disclosure relates to artificial intelligence technology field and, more particularly, to an operation control method and apparatus.

### BACKGROUND

An inference process of an artificial intelligence model usually involves data reading among multi-level memories.

However, bandwidths between some memories of the multi-level memories are relatively small, resulting in relatively time-consuming data transmission. Thus, the inference performance of the artificial intelligence model is affected. Therefore, how to improve the inference performance of the artificial intelligence model is a technical problem that needs to be solved by those skilled in the art.

### SUMMARY

One aspect of this disclosure provides an operation control method including determining a first processing unit for executing an operation sequence that includes at least one operation needed to be executed for processing an inference task based on an artificial intelligence model, and in response to the operation sequence including a target operation that depends on weight data and before the first processing unit obtains target weight data associated with the target operation, scheduling a second processing unit to read the target weight data from a first memory and storing the target weight data into a second memory. The first processing unit and the second processing unit are connected to the second memory, and a data bandwidth between the second memory and the first processing unit and a data bandwidth between the second memory and the second processing unit are greater than a data bandwidth between the second memory and the first memory. The method further includes, during a process of the first processing unit executing the operation sequence, reading the target weight data from the second memory based on the target operation.

Another aspect of this disclosure provides an electronic device including one or more processors and one or more memories storing a computer program that, when executed by the one or more processors, causes the electronic device to determine a first processing unit for executing an operation sequence that includes at least one operation needed to be executed for processing an inference task based on an artificial intelligence model, and in response to the operation sequence including a target operation that depends on weight data and before the first processing unit obtains target weight data associated with the target operation, schedule a second processing unit to read the target weight data from a first memory and storing the target weight data into a second memory. The first processing unit and the second processing unit are connected to the second memory, and a data bandwidth between the second memory and the first processing unit and a data bandwidth between the second memory and the second processing unit are greater than a data bandwidth between the second memory and the first memory. The computer program, when executed by the one or more processors, further causes the electronic device to, during a process of the first processing unit executing the operation sequence, read the target weight data from the second memory based on the target operation.

Another aspect of this disclosure provides a non-transitory computer-readable storage medium storing a computer program that, when executed by one or more processors, causes an electronic device including the one or more processors to determine a first processing unit for executing an operation sequence that includes at least one operation needed to be executed for processing an inference task based on an artificial intelligence model, and in response to the operation sequence including a target operation that depends on weight data and before the first processing unit obtains target weight data associated with the target operation, schedule a second processing unit to read the target weight data from a first memory and storing the target weight data into a second memory. The first processing unit and the second processing unit are connected to the second memory, and a data bandwidth between the second memory and the first processing unit and a data bandwidth between the second memory and the second processing unit are greater than a data bandwidth between the second memory and the first memory. The computer program, when executed by the one or more processors, further causes the electronic device to, during a process of the first processing unit executing the operation sequence, read the target weight data from the second memory based on the target operation.

### BRIEF DESCRIPTION OF THE DRAWINGS

FIG. 1 is a schematic flowchart of an operation control method according to some embodiments of the present disclosure.

FIG. 2 is a schematic diagram of a multi-level storage architecture according to some embodiments of the present disclosure.

FIG. 3 is a schematic flowchart of another operation control method according to some embodiments of the present disclosure.

FIG. 4 is a schematic flowchart of another operation control method according to some embodiments of the present disclosure.

FIG. 5 is a schematic flowchart of another operation control method according to some embodiments of the present disclosure.

FIG. 6 is a schematic flowchart of another operation control method according to some embodiments of the present disclosure.

FIG. 7 is a schematic flowchart of another operation control method according to some embodiments of the present disclosure.

FIG. 8 is a schematic time sequence diagram of a processor processing operations in an operation sequence when an inference task processed by an artificial intelligence model corresponds to the operation sequence according to some embodiments of the present disclosure.

FIG. 9 is a schematic diagram showing an execution logic of two operation sequences decomposed from an inference task of an artificial intelligence mode according to some embodiments of the present disclosure.

FIG. 10 is a schematic time sequence diagram of a single processing unit sequentially processing operations in two operation sequences when an inference task processed by an artificial intelligence model is decomposed into the two operation sequences according to some embodiments of the present disclosure.

FIG. 11 is a schematic time sequence diagram of two processing units processing two operation sequences in parallel according to some embodiments of the present disclosure.

FIG. 12 is a schematic diagram showing comparison between two implementation logics of performing an inference task based on an artificial intelligence model according to some embodiments of the present disclosure.

FIG. 13 is a schematic diagram showing an implementation logic of an operation control method according to some embodiments of the present disclosure.

FIG. 14 is a schematic time sequence diagram of scheduling a weight reading task and two operation sequences according to some embodiments of the present disclosure.

FIG. 15 is a schematic structural diagram of an operation control apparatus according to some embodiments of the present disclosure.

FIG. 16 is a schematic structural diagram of an electronic device according to some embodiments of the present disclosure.

### DETAILED DESCRIPTION

Embodiments of the present disclosure are described below in conjunction with the accompanying drawings in embodiments of the present disclosure. Some terms used in embodiments of the present disclosure are only used to explain specific embodiments of the present disclosure, and are not intended to limit the present disclosure. Those of ordinary skill in the art can know that, with the development of technology and the emergence of new scenarios, the technical solutions of embodiments of the present disclosure are also applicable to similar technical problems.

The terms “first” and “second” in the specification and claims of the present disclosure and in the above accompanying drawings are used to distinguish similar objects, and are not necessarily used to describe a specific order or sequence. The terms used in this way can be interchangeable under appropriate circumstances, which is only a manner of distinction adopted when describing objects with the same attributes in embodiments of the present disclosure. In addition, the terms “comprise,” “include,” and any variations thereof are intended to cover non-exclusive inclusion, so that a process, method, system, product, or device including a series of units is not limited to those units, but can include other units not expressly listed or inherent to such process, method, product, or device.

To improve the inference performance of an inference task of an artificial intelligence model, the present disclosure provides an operation control method. The artificial intelligence model to which the operation control method of the present disclosure is applicable can include any artificial intelligence model having weight parameters. The weight parameters can be adjusted by training the artificial intelligence model. For example, the artificial intelligence model to which the solution of the present disclosure is applicable can include a traditional machine learning model, a deep learning model, a currently commonly used large language model, etc., which is not limited. The operation control method of embodiments of the present disclosure will be described in detail below with reference to the accompanying drawings.

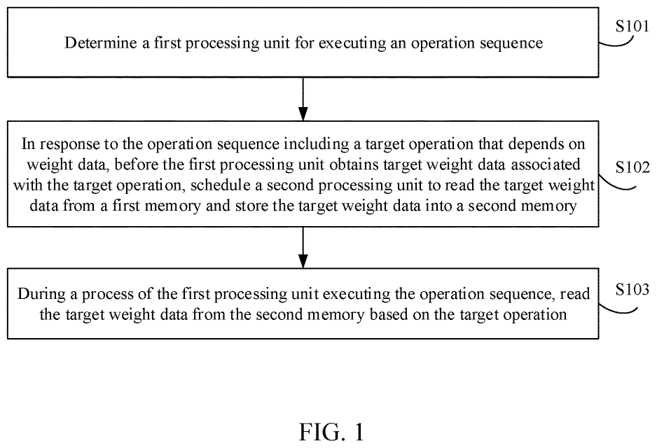

FIG. 1 is a schematic flowchart of an operation control method according to some embodiments of the present disclosure. The method of embodiments of the present disclosure may be applied to an electronic device. The electronic device can include a terminal device such as a notebook computer, a tablet computer, or a desktop computer, and a server, or a device node in a system such as a cloud platform, which is not limited here.

The method of embodiments of the present disclosure includes the following processes.

At S101, a first processing unit configured to execute an operation sequence is determined.

The operation sequence can include at least one operation needed to be executed for processing an inference task based on an artificial intelligence model. In the present disclosure, the inference task based on the artificial intelligence model can include image recognition, image generation, other image processing tasks, or an inference task such as question answering, text information summarization, or data analysis report generation, which are not limited.

In the present disclosure, the operation needed to be executed by the artificial intelligence model for processing the inference task can include different types of computation operations. For example, the computation operations can include computation operations that do not require weight data, such as data addition operations, square root operations on data, or square calculation of data, or computation operations that require computation processing based on weight data. The computation operations that require weight data can include general matrix multiplication (GEMM) operations, convolution operations, or attention mechanism operations, etc.

In the present disclosure, the processing unit can include a neural network processing unit (NPU), a central processing unit (CPU), or other types of processors. The processing unit can also include a processor core. For example, the processing unit can include an NPU processor core or a CPU core, etc.

In some embodiments, the electronic device can include a processing unit set and a scheduling unit. The processing unit set can include a plurality of processing units for executing the inference task based on the artificial intelligence model. The scheduling unit can be connected to each processing unit in the processing unit set. The scheduling unit can be configured to schedule an operation in the operation sequence needed for the artificial intelligence model to process the inference task to a corresponding processing unit. Then, the operations in the operation sequences can be executed by the processing unit. Correspondingly, the electronic device can be configured to determine the first processing unit for executing the operation sequence through the scheduling unit.

At S102, in response to the operation sequence including a target operation dependent on weight data, before the first processing unit obtains target weight data associated with the target operation, a second processing unit is scheduled to read the target weight data from a first memory and store the target weight data into a second memory.

To facilitate differentiation, operations in the operation sequence that need to depend on weight data can be referred to as target operations. For example, if the operations in the operation sequence include a GEMM operation, the GEMM operation can be a target operation. In some embodiments, the operation sequence can include one or more target operations that need to depend on weight data, and the processing procedure for each target operation can be the same.

The first processing unit and the second processing unit can be connected to the second memory. A data bandwidth between the second memory and the first processing unit and a data bandwidth between the second memory and the second processing unit are greater than a data bandwidth between the second memory and the first memory. Since both the first processing unit and the second processing unit are connected to the second memory, the data bandwidth between the second memory and the first processing unit and the data bandwidth between the second memory and the second processing unit can be the data bandwidth between the second memory and any one of the first processing unit and the second processing unit. In some embodiments, the data storage space of the first memory is larger than that of the second memory.

For example, the first memory can include a Double Data Rate (DDR) memory, also referred to as Double Data Rate Synchronous Dynamic Random Access Memory (DDR SDRAM). The second memory can include a level-2 cache shared by the processing units in the processing unit set.

Generally, the weight data needed for the artificial intelligence model to process the inference task can be first stored in the first memory. Based on this, to execute the target operation based on the weight data, the first processing unit may need to first read the weight data from the first memory and store the weight data into the second memory, and then read the corresponding weight data from the second memory. However, since the data bandwidth between the first memory and the second memory is relatively small, the data reading rate for reading the weight data from the first memory can be relatively slow, which can affect the inference performance of the artificial intelligence model in processing the inference task.

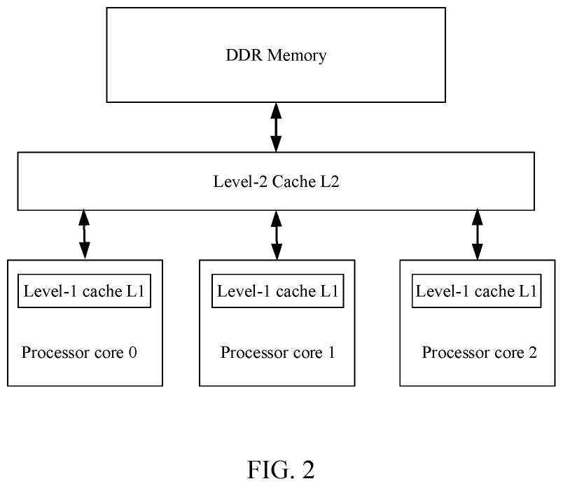

To facilitate understanding, taking the first memory as a DDR memory and the second memory as a level-2 cache shared by the processing units as an example, the description can be performed in conjunction with the multi-level storage architecture shown in FIG. 2.

For example, a processing unit can be a processor core. In the example shown in FIG. 2, three processor cores are provided, i.e., processor core 0, processor core 1, and processor core 2.

As shown in FIG. 2, the storage architecture corresponding to the plurality of processor cores is a three-level cache architecture. Each processor core internally has its own level-1 cache, the processor cores share one level-2 cache, and the DDR memory can be regarded as a level-3 cache. The plurality of processor cores can be connected to the DDR memory through a bus. The data bandwidth between each processor core (or the level-1 cache of the processor core) and the level-2 cache can be relatively large. For example, the data bandwidth can be 64 GB/s. In FIG. 2, since the three processor cores share one level-2 cache, the total data bandwidth between the level-2 cache and the three processor cores reaches 64×3 GB/s. The data bandwidth between the level-2 cache and the DDR memory can be relatively small. For example, the data bandwidth can be 32 GB/s. In the architecture shown in FIG. 2, the processing data needed by the processor core needs to be first moved from the DDR memory to the level-2 cache, and then read from the level-2 cache into the level-1 cache of the processor core to allow the processor core to process the corresponding data.

As shown in FIG. 2, when the processor core executes the target operation, the processor core first reads the weight data from the DDR memory and then caches it into the level-2 cache. The processing efficiency of the processor core in processing the target operation can inevitably be affected due to the relatively long data reading time. Thus, the performance of performing task inference based on the artificial intelligence model can be affected.

Based on this, to reduce the impact on the inference performance of the artificial intelligence model performing the inference task due to the limitation of the data bandwidth between the first memory and the second memory, in the present disclosure, before the first processing unit obtains the target weight data associated with the target operation, the second processing unit can be scheduled to read the target weight data from the first memory and store the target weight data into the second memory. Thus, when the first processing unit needs to read the target weight data, the first processing unit can directly read the target weight data from the second memory.

At S103, during the process of executing the operation sequence by the first processing unit, the target weight data is read from the second memory based on the target operation.

During the process of executing the operation sequence by the first processing unit, if the operation that needs to be executed by the first processing unit is a target operation, the first processing unit can read the target weight data associated with the target operation to execute the computation corresponding to the target operation based on the target weight data.

Since the target weight data has already been stored in the second memory before the first processing unit needs to read the target weight data, when the first processing unit executes the target operation, the first processing unit can directly read the target weight data from the second memory without accessing the first memory again. Thus, the path length for reading the target weight data can be reduced, and the reading efficiency of the target weight data can be improved. Moreover, since the data bandwidth between the second memory and the first processing unit is relatively larger, the first processing unit can more efficiently read the target weight data from the second memory, which also improves the reading efficiency of the first processing unit reading the target weight data.

After the first processing unit reads the target weight data, when the target operation corresponds to a different computation type, the specific computation process executed by the first processing unit based on the target operation can also be different. In the present disclosure, the specific computation process executed by the first processing unit based on the target operation after obtaining the target weight data may not be limited.

From the above content, in the present disclosure, after determining the first processing unit for executing the operation sequence, in response to the presence of a target operation dependent on the weight data in the operation sequence, before the first processing unit acquires the target weight data associated with the target operation, the second processing unit can be first scheduled to read the target weight data from the first memory and store the target weight data into the second memory. Based on this, when the first processing unit needs to read the target weight data based on the target operation, the first processing unit can directly read the target weight data from the second memory. Since the data bandwidth between the second memory and the first processing unit is relatively large, the first processing unit can read the target weight data more efficiently to improve the processing efficiency of the first processing unit processing the target operation. Further, the inference performance of the artificial intelligence model inference task can be improved, and the impact on the inference performance of the artificial intelligence model inference task due to the limitation of the data bandwidth between the first memory and the second memory can be reduced.

In embodiments of the present disclosure, to reduce the impact on performing the inference task based on the artificial intelligence model, an appropriate second processing unit may need to be selected in the present disclosure, and the second processing unit can be scheduled to read the target weight data. Based on this, in the present disclosure, the operating states of the processing units in the processing unit set can be first determined. Correspondingly, in the present disclosure, a second processing unit in the processing unit set and having an operating state meeting requirements can be scheduled to read the target weight data from the first memory and store the target weight data into the second memory.

The processing unit set can include a plurality of processing units configured to execute the inference task based on the artificial intelligence model. For example, the processing unit set can be a preset set of various processing units configured to run the artificial intelligence model. For example, the processing unit set can include processor cores on the processing chip configured to run the artificial intelligence model or processor cores of the same type. For example, the processing unit set can include a plurality of NPU cores.

The operating state of the processing unit can be used to represent a load condition of the processing unit. Based on this, whether the processing unit is in an idle state, whether the processing unit is running operations related to the artificial intelligence model, and the number of to-be-executed operations can be determined according to the operating state of the processing unit.

In the present disclosure, the operating state meeting requirements can be set according to actual needs. For example, the operating state meeting requirements can include being in an idle state, having a load less than a set threshold, or being in an idle state before the first processing unit acquires the target weight data associated with the target operation, etc., which is not limited here.

In the present disclosure, after determining the first processing unit for executing the operation sequence, in the present disclosure, the operations in the operation sequence can be further scheduled to the first processing unit, so that the first processing unit can execute the operations in the operation sequence. A plurality of scheduling manners can be provided to schedule the operations in the operation sequence to the first processing unit. Correspondingly, when a different scheduling manner for scheduling the operations to the first processing unit is provided, a specific implementation of scheduling the second processing unit to read the target weight data can also be different, which is described below.

In some embodiments, in the present disclosure, the operations in the operation sequence can be sequentially scheduled to the first processing unit. Thus, each time the first processing unit finishes executing one operation in the operation sequence, the next to-be-scheduled operation in the operation sequence can be scheduled to the first processing unit. Correspondingly, before scheduling the target operation that needs to depend on the weight data to the first processing unit, the second processing unit can be scheduled to read the target weight data associated with the target operation from the first memory. Based on this, before the first processing unit executes the target operation, the target weight data can be read by the second processing unit from the first memory and stored into the second memory. Then, when the first processing unit executes the target operation, the first processing unit can read the corresponding target weight data from the second memory.

In some other embodiments, in the present disclosure, the operation sequence can also be scheduled to the first processing unit. Thus, the first processing unit can sequentially execute the operations in the operation sequence according to the allocated operation sequence. Correspondingly, before the first processing unit executes the target operation that needs to depend on the weight data, the second processing unit can be scheduled to read the target weight data from the first memory and store the target weight data into the second memory. Then, when the first processing unit executes the target operation, the first processing unit can read the target weight data from the second memory.

The above two possible situations can also be combined with each other. For example, when each time one operation sequence is scheduled to the first processing unit, if the operation sequence has not yet been scheduled to the first processing unit, the target operation has not been scheduled to the first processing unit either. Therefore, before the target operation is scheduled to the first processing unit, the second processing unit can likewise be scheduled to read the target weight data from the first memory and store the target weight data into the second memory.

One or more target operations in the operation sequence that depend on the weight data can be provided. To more accurately and efficiently obtain the target weight data needed by the target operation, in the present disclosure, a weight reading task associated with the target operation can first be determined. On this basis, the weight reading task can be scheduled to the second processing unit. The weight reading task can be used to indicate reading the target weight data from the first memory. Correspondingly, when the second processing unit executes the weight reading task, the second processing unit can read the target weight data from the first memory and store the target weight data into the second memory.

The weight reading task can be a predefined data reading operation.

For example, a data reading operation can be developed in advance and can be separately used to read the target weight data.

For another example, when an artificial intelligence model is deployed, a model data file corresponding to the artificial intelligence model can be compiled. Through encoding, the model data file of the artificial intelligence model can be compiled into executable binary code on electronic devices such as computers, thereby obtaining the operation sequence needed for the artificial intelligence model to execute the inference task. Based on this, the compiling process can be a process of compiling and generating operation codes of the operations in the operation sequence. On this basis, in the present disclosure, during the process of compiling the operation code of the target operation, the operation part of the target operation used for reading the target weight data from the first memory can be separated independently to form a new data reading operation. The data reading operation can be a weight reading task for reading the target weight data from the first memory to the second memory.

The compiling of the model data file may only need to be executed once when the artificial intelligence model is deployed on the electronic device. After the model data file is compiled into the binary code, the operation sequence needed for the artificial intelligence model to execute the inference task can be obtained. Therefore, when the artificial intelligence model is called each time thereafter, the compiling operation may not be performed again. The specific compiling process is not limited in the present disclosure.

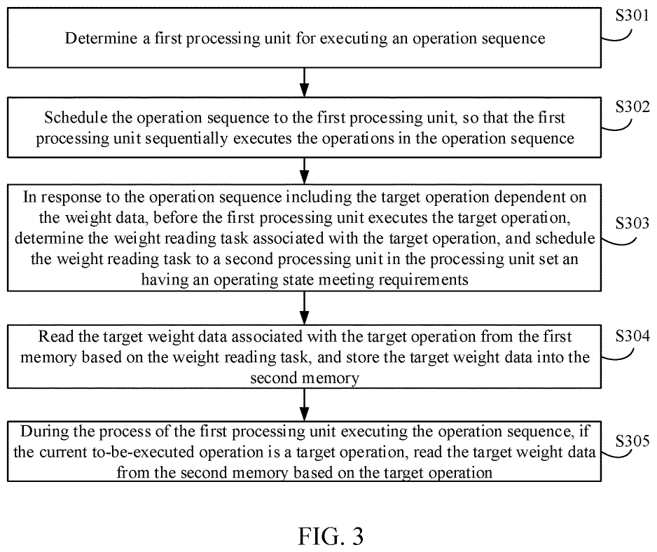

When the weight reading task is scheduled to the second processing unit, determining the second processing unit and the specific timing of scheduling the weight reading task to the second processing unit can refer to the above description. To facilitate understanding, one implementation manner can be described below as an example. FIG. 3 is a schematic flowchart of another operation control method according to some embodiments of the present disclosure. The method includes the following processes.

At S301, a first processing unit for executing an operation sequence is determined.

The operation sequence can include at least one operation that needs to be executed for processing an inference task based on an artificial intelligence model.

At S302, the operation sequence is scheduled to the first processing unit, so that the first processing unit sequentially executes the operations in the operation sequence.

At S303, in response to the operation sequence including the target operation dependent on the weight data, before the first processing unit executes the target operation, the weight reading task associated with the target operation is determined, and the weight reading task is scheduled to a second processing unit in the processing unit set and having an operating state meeting requirements.

For the second processing unit having an operating state meeting requirements, reference can be made to the above related description. For example, the weight reading task can be scheduled to a second processing unit in an idle state. Thus, the second processing unit can execute the weight reading task in a timely manner.

If a plurality of target operations are provided in the operation sequence, different target operations can be associated with different weight reading tasks. The second processing units corresponding to different weight reading tasks may be the same or may be different. For example, the second processing units corresponding to different weight reading tasks may be determined in combination with the operating states of each processing unit in the processing unit set.

To facilitate understanding, in some embodiments, the operation sequence can be scheduled as a whole to the first processing unit. Therefore, before executing the target operation, the first processing unit can be configured to determine the weight reading task associated with the target operation. However, if scheduling the operations in the operation sequence to the first processing unit is replaced with another implementation manner, the implementation manner can be also applicable to the present disclosure, as long as the weight reading task is scheduled to the second processing unit before the first processing unit needs to obtain the target weight data associated with the target operation, which is not repeated here.

At S304, the second processing unit reads the target weight data associated with the target operation from the first memory based on the weight reading task, and stores the target weight data into the second memory.

The first processing unit and the second processing unit can be connected to the second memory. The data bandwidth between the second memory and the first processing unit and the second processing unit can be greater than the data bandwidth between the second memory and the first memory.

In the present disclosure, the weight reading task can be used to indicate reading the target weight data associated with the target operation from the first memory. Based on this, the second processing unit can be configured to read the target weight data from the first memory based on the weight reading task and store the target weight data into the second memory.

At S305, during the process of the first processing unit executing the operation sequence, if the current to-be-executed operation is a target operation, the first processing unit reads the target weight data from the second memory based on the target operation.

For the specific implementation of step S305, reference can be made to the related description above, which is not repeated here.

In addition to storing the weight data associated with the target operation, the second memory can also store input data needed by other operations. For example, assuming that image processing, such as image generation or text character recognition in an image, needs to be executed based on an artificial intelligence model, then during the process of the processing unit executing the inference task based on the artificial intelligence model, the second storage unit can also store image data of a to-be-processed image. The image data can be input data that needs to be input into the artificial intelligence model for processing. Based on this, to enable the first processing unit to accurately read the target weight data associated with the target operation from the second memory, in the present disclosure, during the process of compiling the operation code corresponding to the target operation, a target data storage area allocated for the target operation and configured to store the weight data can be determined from the second memory.

Correspondingly, during the process of compiling the operation code corresponding to the target operation, a target attribute parameter used to represent the target data storage area can be generated for the target operation. The target attribute parameter can include address information indicating the presence of the target data storage area.

For example, the initial value of the target attribute parameter of the target operation can be empty. The target data storage area can be allocated to the target operation. Then, the value of the target attribute parameter in the target operation can be set as the address information corresponding to the target data storage area.

Based on the above, the second processing unit can be scheduled to store the target weight data associated with the target operation into the target data storage area in the second memory. Correspondingly, when the first processing unit executes the target operation, the first processing unit can read the target weight data from the target data storage area based on the address information indicated by the target attribute parameter in the target operation.

If the second processing unit does not need to be pre-scheduled to read the target weight data from the first memory before the first processing unit needs to obtain the target weight data, then in the compilation stage, the target data storage area may not be allocated for the target operation, and the target attribute parameter may not be generated for the target operation. Based on this, if the target attribute parameter in the target operation is empty, the first processing unit can read the target weight data from the first memory based on the target operation.

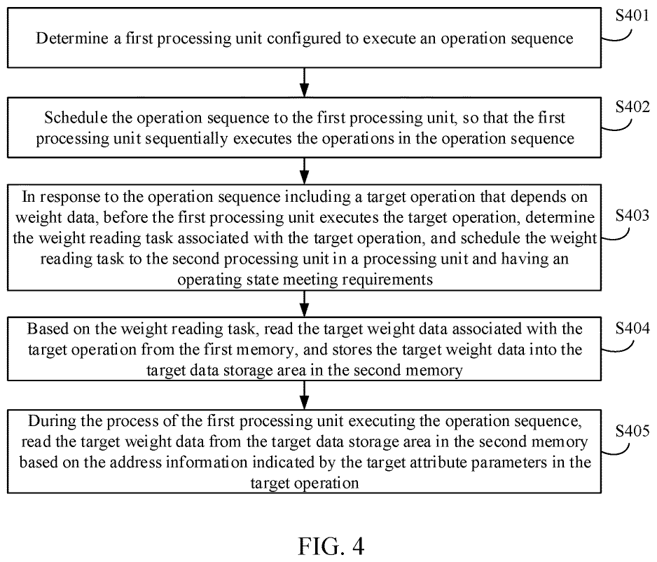

To facilitate understanding, the second processing unit can be scheduled to read the target weight data from the first memory by scheduling the weight reading task to the second processing unit. FIG. 4 is a schematic flowchart of another operation control method according to some embodiments of the present disclosure. The method can include the following processes.

At S401, a first processing unit configured to execute an operation sequence is determined.

The operation sequence can include at least one operation needed to be executed for processing an inference task based on the artificial intelligence model.

At S402, the operation sequence is scheduled to the first processing unit, so that the first processing unit sequentially executes the operations in the operation sequence.

At S403, in response to the operation sequence including a target operation that depends on the weight data, before the first processing unit executes the target operation, the weight reading task associated with the target operation is determined, and the weight reading task is scheduled to the second processing unit in a processing unit set and having an operating state meeting requirements.

Before executing the target operation by the first processing unit may be any time point before the first processing unit executes the target operation, for example, when the operation sequence is scheduled to the first processing unit, when the operation currently executed by the first processing unit is the operation preceding the target operation, when the operation currently to be executed by the first processing unit is the target operation, or other possible situations, which is not described here again.

The weight reading task can be a pre-generated data reading operation for reading the target weight data associated with the target operation. For details, reference can be made to the above description, which is not repeated here.

The weight reading task can be used to indicate reading the target weight data associated with the target operation from the first memory.

In some embodiments, address attribute parameters of the weight reading task can indicate a target storage address of the target weight data in the first memory, and address information corresponding to a target data storage area in the second memory for storing the target weight data.

For example, during a process of compiling the operation code corresponding to the target operation, the target storage address of the target weight data needed by the target operation in the first memory can be determined. Moreover, during the process of compiling the operation code corresponding to the target operation, a target data storage area allocated for the target operation in the second memory for storing weight data can also be determined. Based on this, during a compilation stage of compiling the weight reading task, the target storage address of the target weight data in the first memory and the address information corresponding to the target data storage area in the second memory can be added into the address attribute parameters of the weight reading task.

For example, if the weight reading task is a data reading operation pre-developed for the target operation, during the process of compiling the operation code of the weight reading task associated with the target operation, two parameter values can be added into the address attribute parameters of the weight reading task. The two parameter values can be the target storage address of the target weight data in the first memory and the address information corresponding to the target data storage area in the second memory, respectively. For another example, if the weight reading task is separated during the process of compiling the operation code of the target operation, the target storage address of the target weight data in the first memory and the address information corresponding to the target data storage area can be added into the address attribute parameters of the weight reading task.

In embodiments of the present disclosure, scheduling the operation sequence to the first processing unit can be taken as an example for description. However, sequentially scheduling the operations in the operation sequence to the first processing unit can also be applicable to embodiments of the present disclosure. For example, when the operations in the operation sequence are sequentially scheduled to the first processing unit, step S403 can be replaced with, in response to a target operation that depends on the weight data existing in the operation sequence, determining the weight reading task associated with the target operation and scheduling the weight reading task to the second processing unit in the processing unit set and having an operating state meeting requirements, before scheduling the target operation to the first processing unit.

At S404, the second processing unit, based on the weight reading task, reads the target weight data associated with the target operation from the first memory, and stores the target weight data into the target data storage area in the second memory.

The target data storage area can be a storage area allocated to the target operation for storing the weight data during the process of compiling the operation code corresponding to the target operation.

In some embodiments, if the address attribute parameters of the weight reading task indicate the target storage address of the target weight data in the first memory and the address information corresponding to the target data storage area in the second memory for storing the target weight data, the second processing unit can read the target weight data from the first memory based on the target storage address indicated by the address attribute parameters in the weight reading task, and store the target weight data into the target data storage area in the second memory based on the address information corresponding to the target data storage area indicated by the address attribute parameters.

At S405, during the process of the first processing unit executing the operation sequence, the first processing unit reads the target weight data from the target data storage area in the second memory based on the address information indicated by the target attribute parameters in the target operation.

The target attribute parameters can be parameters generated by the target operation for representing the target data storage area during the process of compiling the operation code corresponding to the target operation.

In any embodiment of allocating the target data storage area for the target operation during the compiling stage, the storage space of the target data storage area allocated to the target operation in the second memory can be relatively limited. Thus, the target data storage area can be insufficient to store the target weight data corresponding to the target operation. When the target data storage area is insufficient to store the target weight data, to ensure the first processing unit is still able to directly read the target data storage area from the second memory, the target weight data can be divided into blocks in the present disclosure, and the blocks of the target weight data can be stored in the target data storage area in batches.

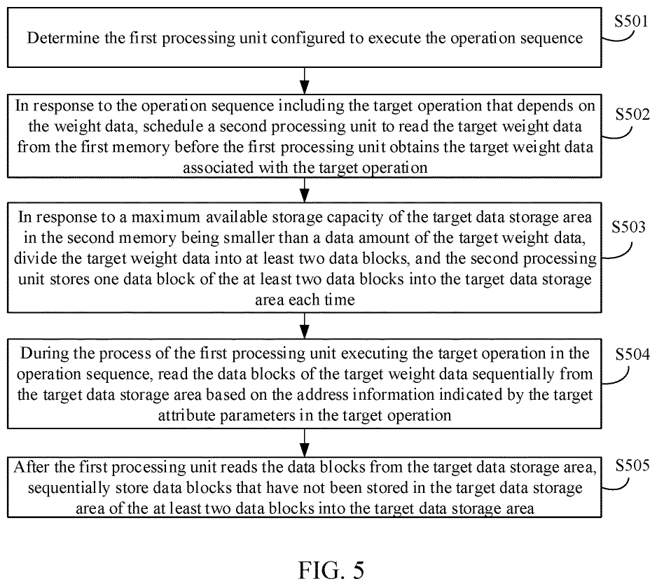

FIG. 5 is a schematic flowchart of another operation control method according to some embodiments of the present disclosure. The method of embodiments of the present disclosure includes the following processes.

At S501, the first processing unit configured to execute the operation sequence is determined.

The operation sequence can include at least one operation needed to be executed for processing an inference task based on the artificial intelligence model.

At S502, in response to the operation sequence including the target operation that depends on the weight data, a second processing unit is scheduled to read the target weight data from the first memory before the first processing unit obtains the target weight data associated with the target operation.

For example, the weight reading task can be scheduled to the second processing unit to allow the second processing unit to read the target weight data from the first memory and perform the subsequent related operations.

For scheduling the second processing unit to read the target weight data, reference can be made to related descriptions in any above embodiments, which are not repeated here.

At S503, in response to a maximum available storage capacity of the target data storage area in the second memory being smaller than a data amount of the target weight data, the target weight data is divided into at least two data blocks, and the second processing unit stores one data block of the at least two data blocks into the target data storage area each time.

The first processing unit and the second processing unit can be connected to the second memory, and the data bandwidths between the second memory and the first processing unit and between the second memory and the second processing unit can be greater than the data bandwidth between the second memory and the first memory.

The target data storage area can be the storage area allocated for the target operation for storing the weight data during the process of compiling the operation code corresponding to the target operation.

The maximum available storage capacity of the target data storage area can be a maximum data amount that can be stored in the target data storage area.

In the present disclosure, dividing the target weight data into the at least two data blocks can be performed by a scheduling unit, e.g., the second processing unit, which is not limited.

In some embodiments, a size of each data block obtained by dividing the target weight data can be smaller than or equal to the maximum available storage capacity. The second processing unit can, each time, only read one data block obtained by dividing the target weight data from the first memory and store the data block into the target data storage area of the second memory, and continuously repeat this operation until no free storage space exists in the target data storage area.

At S504, during the process of the first processing unit executing the target operation in the operation sequence, the data blocks of the target weight data are read sequentially from the target data storage area based on the address information indicated by the target attribute parameters in the target operation.

At S505, after the first processing unit reads the data blocks from the target data storage area, the second processing unit sequentially stores data blocks, that have not been stored into the target data storage area, of the at least two data blocks into the target data storage area.

Since the maximum available storage capacity of the target data storage area is less than the data amount of the target weight data, at S503, only a part of the data blocks obtained by dividing the target weight data can be stored into the target data storage area, and data blocks of the at least two data blocks obtained by dividing the target weight data may still not be stored in the target data storage area. After the first processing unit reads the data blocks from the target data storage area, idle storage space can appear again in the target data storage area. Thus, the second processing unit can continue to read data blocks that have not been stored in the target data storage area and store the read data blocks into the target data storage area.

Each time the first processing unit reads one data block from the target data storage area, the second processing unit can store one data block of the target weight data into the target data storage area, until no unread data block exists in the target weight data stored in the first memory.

The operation needed to be executed for processing the inference task based on the artificial intelligence model can involve computational processing of the input data needed by the operation. Based on this, if the first processing unit, when executing each operation, reads input data corresponding to the operation from the first memory, since the data bandwidth between the first memory and the second memory is relatively small, the first processing unit can be unable to efficiently obtain the input data corresponding to the operation. Thus, the performance of processing the inference task based on the artificial intelligence model can be affected.

Based on this, to allow the first processing unit to process the operations in the operation sequence more efficiently, in the present disclosure, after the first processing unit completes the computational processing corresponding to each operation, the first processing unit can store the output data generated by performing the operation into the second memory. For a first operation and a second operation that are adjacent in the operation sequence, output data generated by the first operation can actually be input data needed to be processed in the second operation. Based on this, since the output data of the first operation is cached in the second memory, when the first processing unit executes the second operation, the first processing unit can directly read the input data needed to be processed in the second operation from the second memory. Thus, frequent access to the first memory can be avoided.

Thus, in the present disclosure, if a to-be-processed operation of the first processing unit is the first operation in the operation sequence, the first processing unit can read the input data needed in the first operation from the first memory. If the to-be-processed operation of the first processing unit is not the first operation in the operation sequence, the first processing unit can directly read the input data needed to be processed in the non-first operation from the second memory. Thus, a number of times the first processing unit needs to access the first memory can be reduced, the data reading efficiency of the first processing unit can be improved, the efficiency of the first processing unit processing the operation sequence can be further improved, and the efficiency of processing the inference task based on the artificial intelligence model can be improved.

Since the first processing unit is not directly connected to the first memory, the first processing unit reading the input data needed in the operation from the first memory can include reading the input data needed in the operation from the first memory, caching the input data needed in the operation into the second memory, and reading the input data needed by the operation from the second memory.

Further, considering that the storage space of the second memory is normally smaller than the storage space of the first memory, to reduce a situation in which the output data generated by the first processing unit executing the operation cannot be cached in the second memory due to insufficient storage space of the second memory, in the present disclosure, an initial operation sequence involved in processing the inference task by the artificial intelligence model can also be divided in advance into at least two operation sequences. The data needed to be processed by the initial operation sequence can be divided into at least two pieces of input data, respectively, needed to be processed by the at least two operation sequences. The input data needed to be processed by different operation sequences can be different.

Correspondingly, different operation sequences can include the same number of operations. Operations at the same sequence position of different operation sequences can correspond to the same operation type. Thus, the data needed to be processed by the initial operation sequence can be assigned to the at least two operation sequences for processing.

In the process of executing the inference task based on the artificial intelligence model, computational processing can be performed on each piece of data in the data set of the artificial intelligence model sequentially through various operations in the artificial intelligence model. Since each operation sequence includes the same operation types and various operations needed for the artificial intelligence model to execute the inference task, the data set needed to be processed by the artificial intelligence model can be divided into at least two portions of input data, which can be processed in parallel by the at least two operation sequences, and each portion of input data can be ensured to be calculated and processed by various operations in the artificial intelligence model. Thus, the result after fusing the output data obtained after processing portions of input data can be consistent with the result obtained by an initial operation sequence processing the data set.

For example, assume that the data set needed to be processed by the artificial intelligence model can be a feature matrix of an image. To facilitate the description, only one operation, namely the target operation in the artificial intelligence model based on the weight data, can be taken as an example for illustration.

In the present disclosure, the feature matrix of the image can be divided into a plurality of sub-matrices, and the plurality of sub-matrices can be combined to obtain the feature matrix of the image. Since the plurality of operation sequences corresponding to the artificial intelligence model each can include the target operation, when the sub-matrices are allocated to different operation sequences for processing, each sub-matrix can be calculated with the weight matrix (i.e., weight data) in the target operation of the corresponding operation sequence, such that each sub-matrix in the feature matrix of the image can be computed with the weight matrix associated with the target operation. Then, the submatrices can be multiplied with the weight matrix associated with the target operation and then fused to obtain the output result, i.e., the output result obtained by directly multiplying the feature matrix of the image with the weight matrix associated with the target operation.

Based on this, in the present disclosure, at least two operation sequences needed to be executed for processing the inference task by the artificial intelligence model can be determined. Correspondingly, for each operation sequence, the first processing unit configured to execute the operation sequence can be determined. As described above, operation types corresponding to operations at the same sequential position in different operation sequences are the same. However, input data processed by different operation sequences can be different.

For example, assume that the initial operation sequence needed to be executed for processing an inference task by the artificial intelligence model is divided into two operation sequences. The input data to be processed by the initial operation sequence can be divided into two portions, which are the first input data and the input data. Assume that the artificial intelligence model processing the inference task can include sequentially performing data addition computation, data multiplication computation, and GEMM computation on data in the data set. Then, operation sequence 1 and operation sequence 2 can be determined to be executed for processing the inference task by the artificial intelligence model. Operation sequence 1 can sequentially include data addition computation, data multiplication computation, and GEMM computation, and operation sequence 2 can also sequentially include data addition computation, data multiplication computation, and GEMM computation. Based on operation sequence 1, data addition computation, data multiplication computation, and GEMM computation may need to be sequentially performed on the first input data, while based on operation sequence 2, data addition computation, data multiplication computation, and GEMM computation may need to be sequentially performed on the second input data.

Since the operation types corresponding to the operations at a same sequential position in different operation sequences are the same, if an operation at a certain sequential position in one operation sequence can be the target operation that depends on the weight data, then operations at corresponding sequential positions in other operation sequences are also the same type of target operation that depends on the weight data.

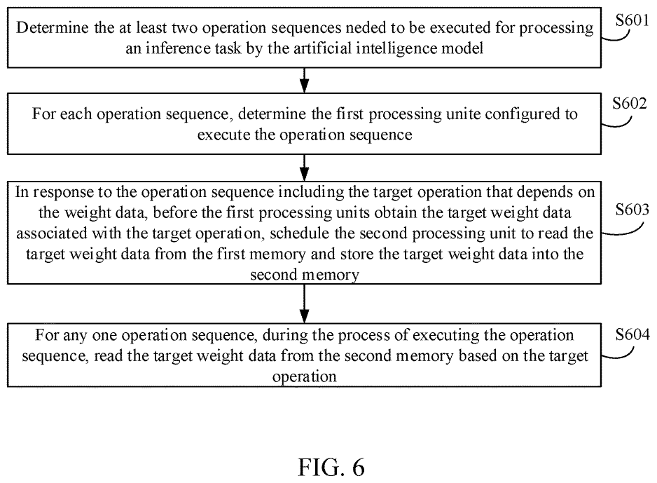

In particular, since different operation sequences only differ in processing different input data, specific computational operations sequentially executed in the operation sequences can be the same. Based on this, all weight data needed by the target operations that are at the same sequential position in different operation sequences and depend on the weight data can be the same. For this situation, FIG. 6 is combined for description.

FIG. 6 is a schematic flowchart of another operation control method according to some embodiments of the present disclosure. The method in embodiments of the present disclosure includes the following processes.

At S601, the at least two operation sequences needed to be executed for processing an inference task by the artificial intelligence model are determined.

The operation sequence can include at least one operation having a sequential order. Operation types corresponding to operations at the same sequential position in different operation sequences can be the same. However, input data processed by different operation sequences can be different.

In the present disclosure, the specific implementation process for dividing the initial operation sequence needed to be executed by the artificial intelligence processing model into at least two operation sequences may not be limited.

At S602, for each operation sequence, the first processing unit configured to execute the operation sequence is determined.

In the present disclosure, the first processing units corresponding to the at least two operation sequences, respectively, can be the same, completely different, or partially same, which is not specifically limited.

In some embodiments, to fully utilize the computing resources of the processing units in the electronic device and improve the performance of processing the inference task by the artificial intelligence model, the at least two processing units can be configured to execute the at least two operation sequences in parallel to improve the performance of processing the inference task by the artificial intelligence model. Based on this, the first processing units corresponding to different operation sequences can be different.

At S603, in response to the operation sequence including the target operation that depends on the weight data, before the first processing units obtain the target weight data associated with the target operation, the second processing unit is scheduled to read the target weight data from the first memory and store the target weight data into the second memory.

The first processing unit and the second processing unit can be connected to the second memory. The data bandwidth between the second memory and the first processing unit and between the second memory and the second processing unit can be greater than the data bandwidth between the second memory and the first memory.

In the present disclosure, the weight data needed by the target operations that are at the same sequential position in different operation sequences and depend on the weight data can be the same. Based on this, for the target operations at the same sequential position in the plurality of operation sequences, the second processing unit may only need to be configured to read the target weight data corresponding to the target operation from the first memory, without needing to read the target weight data from the first memory a plurality of times.

Before adopting the solution of the present disclosure, since each operation sequence includes the same type of target operation, each first processing unit, every time executing the target operation of that type in one operation sequence, may need to read the target weight data of the target operation from the first memory. Therefore, when more operation sequences are provided, the target weight data may need to be repeatedly read from the first memory more times. The target weight data can be repeatedly read from the first memory more times, the read bandwidth of the first memory can be occupied more, thereby being less beneficial for efficient data reading, further affecting the execution of the operation sequences, and naturally affecting the efficiency of executing the inference task by the artificial intelligence model.

However, in the solution of the present disclosure, the inference task executed by the artificial intelligence model can be divided into a plurality of operation sequences. The plurality of first processing units can be configured to execute the plurality of operation sequences to improve the inference efficiency of the inference task. Before the first processing units execute the target operations in the operation sequences, the second processing unit can be configured to read the target weight data associated with the target operations into the second memory in advance. Then, when executing the target operations, the first processing units can directly read the target weight data from the second memory with extremely high data reading bandwidth. Then, the impact on the inference efficiency of the inference task caused by repeatedly reading the target weight data from the first memory a plurality of times can be further reduced, and the inference efficiency of the inference task can be naturally improved.

In the present disclosure, for scheduling the second processing unit to read the target weight data from the first memory and store the target weight data into the second memory, reference can be made to the related descriptions above, which are not repeated here.

At S604, for any one operation sequence, during the process of executing the operation sequence, the first processing unit reads the target weight data from the second memory based on the target operation.

For the implementation of each first processing unit executing the corresponding operation sequence, reference can be made to the related description above, which is not repeated here.

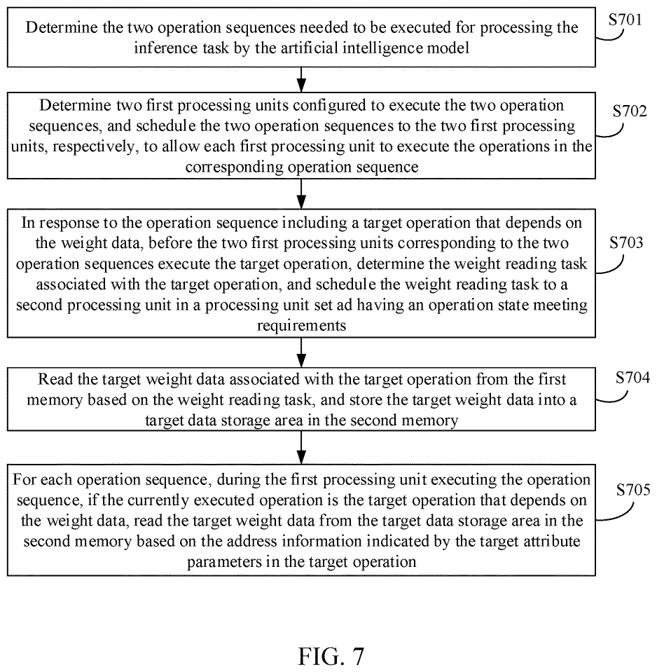

To facilitate understanding the advantages of the solution of the present disclosure, the following description is given by taking an example that two operation sequences are needed to be executed for processing an inference task by the artificial intelligence model, and in connection with a possible implementation of FIG. 7. FIG. 7 is a schematic flowchart of another operation control method according to some embodiments of the present disclosure. The method of embodiments of the present disclosure includes the following processes.

At S701, the two operation sequences needed to be executed for processing the inference task by the artificial intelligence model are determined.

The operation sequence can include at least one operation having a sequential order. Operation types corresponding to operations at the same sequential position in different operation sequences can be the same. However, input data processed by different operation sequences can be different.

At S702, two first processing units configured to execute the two operation sequences are determined, and the two operation sequences are scheduled to the first processing units, respectively, to allow each first processing unit to execute the operations in the corresponding operation sequence.

Different operation sequences can be scheduled to different first processing units.

In some embodiments, scheduling the two operation sequences to two different first processing units can allow the two first processing units to process the operations in the two operation sequences in parallel, thereby improving processing efficiency of the artificial intelligence model processing the inference task, and naturally improving the inference performance.

At S703, in response to the operation sequence including a target operation that depends on the weight data, before the two first processing units corresponding to the two operation sequences execute the target operation, the weight reading task associated with the target operation is determined, and the weight reading task is scheduled to a second processing unit in a processing unit set and having an operating state meeting requirements.

In the present disclosure, the weight data needed by the target operations that are at the same sequential position in the two operation sequences and depend on the weight data can be the same. Therefore, for the same type of target operation in the two operation sequences, the target operations in the two operation sequences can correspond to the same weight reading task, and the weight reading task may only need to be scheduled once.

For example, operations at a third position in the two operation sequences can both be the same type of GEMM operation. Since the two GEMM operations both belong to a computational operation needed to be executed at the third based on the artificial intelligence model, the weight data on which the GEMM operations depend in the two sequences can be the same, and the weight scheduling task used to obtain the weight data corresponding to the GEMM operation may need to be scheduled only once.

The weight reading task can be used to indicate reading the target weight data associated with the target operation from the first memory.

At S704, the second processing unit reads the target weight data associated with the target operation from the first memory based on the weight reading task, and store the target weight data into a target data storage area in the second memory.

The target data storage area can be a storage area allocated for the target operation for storing the weight data during the process of compiling the operation code corresponding to the target operation.

At S705, for each operation sequence, during the process of the first processing unit executing the operation sequence, if the currently executed operation is the target operation that depends on the weight data, the first processing unit reads the target weight data from the target data storage area in the second memory based on the address information indicated by the target attribute parameters in the target operation.

In embodiments of the present disclosure, for any operation in the operation sequence, when the computational processing corresponding to the operation is executed, the input data corresponding to the operation may need to be obtained. As described above, when executing the operation sequence by the first processing unit, if the currently executed operation is the first operation in the operation sequence, the first processing unit can read the input data corresponding to the first operation from the first memory, execute the computational processing corresponding to the first operation based on the input data corresponding to the first operation, and store the output data generated by the first operation into the second memory.

If the currently executed operation is a non-first operation in the operation sequence, since the input data of the non-first operation is the output data generated by a previous operation of the non-first operation, the input data of the non-first operation can be directly read from the second memory. Thus, the number of times for the first processing unit accessing the first memory when executing the operation sequence can be reduced, and the data reading efficiency can be improved. Correspondingly, after executing the computational processing corresponding to the non-first operation based on the input data corresponding to the non-first operation, the output data generated by the non-first operation can be stored into the second memory.

The target operation can be the first operation in the operation sequence or a non-first operation. For the target operation, the first processing unit can execute the computational processing corresponding to the target operation based on the input data corresponding to the target operation and the target weight data, and store the output result generated by the target operation into the second memory.

In some embodiments, if the currently processed operation by the first processing unit is the last operation in the operation sequence, the first processing unit can further transfer the output result generated by the last operation from the second memory to the first memory.

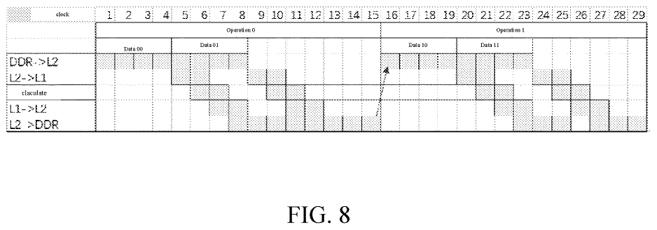

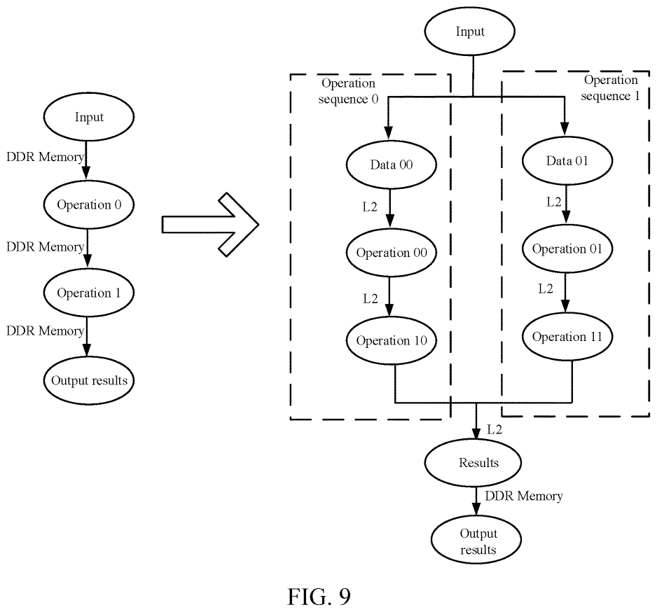

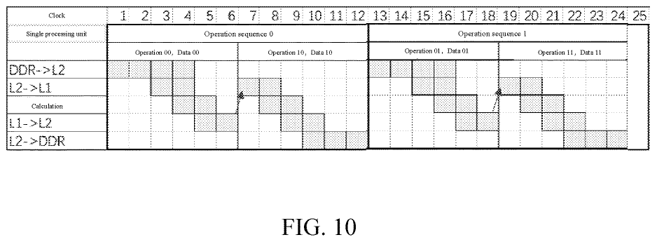

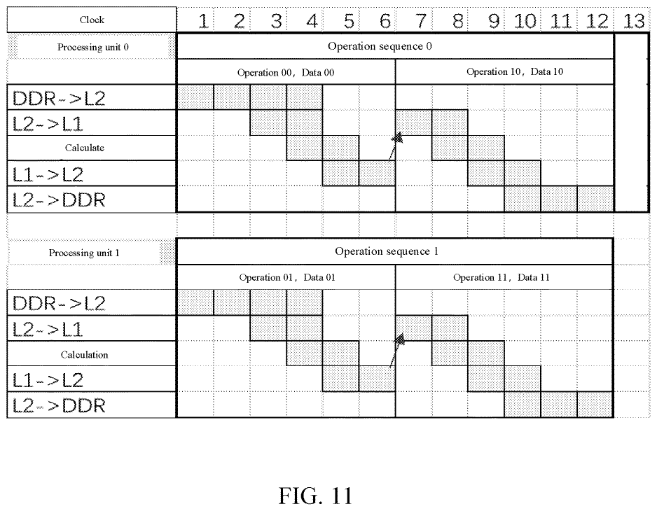

To facilitate understanding of the advantages of dividing the inference task of the artificial intelligence model into two operation sequences, and the advantages of the first processing unit reading the input data needed by the operations from the second memory, the description is given in conjunction with FIG. 8, FIG. 9, FIG. 10, and FIG. 11. To facilitate understanding, a storage architecture corresponding to the processing unit being the storage architecture shown in FIG. 2 is taken as an example for description.

FIG. 8 is a schematic time sequence diagram of a processor processing operations in an operation sequence when an inference task processed by an artificial intelligence model corresponds to the operation sequence according to some embodiments of the present disclosure.

To facilitate understanding and description, in FIG. 8, operation 0 and operation 1 involved in the inference task of the artificial intelligence model are taken as an example. That is, the operation sequence sequentially includes operation 0 and operation 1. To facilitate understanding of dividing the inference task into two operation sequences, in FIG. 8, input data needed by operation 0 includes data 00 and data 01. Considering data processing of the artificial intelligence model, in FIG. 8 and in the following examples, data usually refers to a data matrix consisting of a plurality of pieces of data. For example, data 00 and data 01 can be two different data matrices. Input data needed by operation 1 can include data 10 and data 11. Data 10 can be output data obtained by the processing unit performing the computational processing on data 00 based on operation 0. Data 11 can be output data obtained by the processing unit performing the computational processing on data 01 based on operation 0.

As shown in FIG. 8, when executing operation 0, the processing unit needs to sequentially read data 00 and data 01 from a DDR memory, and cache data 00 and data 01 into a level-2 cache L2. Then, data 00 and data 01 are sequentially read from the level-2 cache L2 into a level-1 cache L1 of the processing unit. After the processing unit reads data 00 into the level-1 cache L1, the processing unit performs the computational processing corresponding to operation 0 on data 00, and stores output data obtained by computation into the DDR memory via the level-1 cache L1 and the level-2 cache L2. Similarly, after reading data 01 into the level-1 cache L1, the processing unit performs the computational processing on data 01 based on operation 0, and stores output data obtained by computation into the DDR memory via the level-1 cache L1 and the level-2 cache L2.

After completing the processing of operation 0, the processing unit can continue to execute operation 1. During the execution of operation 1, the processing unit reading and processing of data 10 and data 11 can be similar to the processing unit executing operation 0, which is not repeated here.

As shown in FIG. 8, when executing operation 0 and operation 1, the processing unit needs to first read the input data needed by the operations from the DDR memory and store the computed output data into the DDR memory. Thus, the processing units may need to access the DDR memory many times. Due to the limitation of the bandwidth between the DDR memory and the level-2 cache L2, the data storage and reading speed can be slow, which affects the efficiency of the processing unit processing operation 0 and operation 1. As shown in FIG. 8, the processing unit needs 29 clock cycles to finish processing operation 0 and operation 1 (i.e., completing the inference task of the artificial intelligence model).

FIG. 9 is a schematic diagram showing an execution logic of two operation sequences decomposed from an inference task of an artificial intelligence mode according to some embodiments of the present disclosure.

The initial operation sequence corresponding to the inference task of the artificial intelligence model is shown on the left side of the arrow in FIG. 9. The initial operation sequence includes operation 0 and operation 1. The input data needed to be processed by operation 0 and operation 1 both need to be read from the DDR memory. For the processing process corresponding to the execution of the initial operation sequence, reference can be made to the related description of FIG. 8 above.

An implementation logic example is shown on the right side of the arrow in FIG. 9 after dividing the inference task of the artificial intelligence model into the two operation sequences. To facilitate distinction, the two operation sequences can be referred to as operation sequence 0 and operation sequence 1, respectively. Each operation sequence after division can still include two operations. To facilitate distinction, two operations of operation sequence 0 can be referred to as operation 00 and operation 10, respectively. Two operations of operation sequence 1 can be referred to as operation 01 and operation 11, respectively.

Operation 00 in operation sequence 0 and operation 01 in operation sequence 1 can belong to the same type of operation as operation 0 in the initial operation sequence. Therefore, the computation processing performed by operation 00 and operation 01 on the input data can be the same as the computation processing performed by operation 0 on the input data. For example, if operation 0 includes performing an addition operation on the input data, operation 00 and operation 01 can also include performing addition operations on the input data. Correspondingly, operation 10 in operation sequence 0 and operation 11 in operation sequence 1 can also be the same type of operation as operation 1 in the initial operation sequence. However, the input data corresponding to operation sequence 0 can be data 00. Therefore, the input data of operation 00 in operation sequence 0 can be data 00, and the input data 10 of operation 10 can be the output data obtained by the computation of operation 00. The input data corresponding to operation sequence 1 can be data 01. Therefore, the input data of operation 01 can be data 01, and the input data of operation 11 can be data 11 output by operation 01.

As shown in FIG. 9, when data 00 is cached in the level-2 cache L2 based on operation 00 in operation sequence 0, operation 11 is executed based on data 00 cached in the level-2 cache L2, and the data 10 output by executing operation 00 is also stored in the level-2 cache L2. Based on this, when operation 10 is executed, data 10 can be directly read from the level-2 cache L2. Similarly, after data 01 is cached in the level-2 cache L2 based on operation 01 in operation sequence 1, the computation processing corresponding to operation 01 can be performed based on data 01 in the level-2 cache, and the computed data 11 is cached in the level-2 cache L2. Then, when operation 11 is executed, data 11 can be directly read from the level-2 cache L2.

To facilitate understanding of the efficiency of executing the inference task of the artificial intelligence model based on operation sequence 0 and operation sequence 1, the description is provided in connection with FIG. 10. FIG. 10 is a schematic time sequence diagram of a single processing unit sequentially processing operations in two operation sequences when an inference task processed by an artificial intelligence model is decomposed into the two operation sequences according to some embodiments of the present disclosure.

As shown in FIG. 10, operation sequence 0 and operation sequence 1 are sequentially scheduled to the same processing unit.

As shown in FIG. 10, first, the processing unit reads data 00 from the DDR memory based on operation 00 in operation sequence 0 and caches data 00 into the level-2 cache L2, and then reads the data 00 from the level-2 cache L2 into the level-1 cache L1. Then, the processing unit performs computation processing on input data 00 in the level-1 cache L1 based on operation 00, and caches the output data obtained by the computation (i.e., data 10) from the level-1 cache L1 into the level-2 cache L2.

When executing operation 10 in operation sequence 0, the processing unit can directly read data 10 obtained by the computation of operation 00 from the level-2 cache L2 and cache data 10 in the level-1 cache L1. Then, after performing the computation processing on data 10 based on operation 10, the processing unit can store the computed data into the DDR memory via the level-1 cache L1 and the level-2 cache L2 to complete the processing of operation sequence 0.

After completing the processing of operation sequence 0, the processing unit can execute operation sequence 1. The process of the processing unit executing the operations in operation sequence 1 can be similar to the process of the processing unit executing the operations in operation sequence 0, which is shown in the time diagram of FIG. 10, and is not repeated here.

By comparing FIG. 8 and FIG. 10, the total number of times the processing unit reads data from and stores data to the DDR memory is 8 in FIG. 8 (i.e., the number of accesses to the DDR memory is 8). In FIG. 10, the total number of times the processing unit reads data from and writes data to the DDR memory is 4. Therefore, in FIG. 10, the number of accesses to the DDR memory needed when the processing unit executes the two operation sequences is reduced. Moreover, completing the inference task in FIG. 8 requires 28 clock cycles, while completing the task inference in FIG. 10 (i.e., after the processing unit completes executing the two operation sequences) requires only 24 clock cycles. Thus, the inference efficiency of executing the task inference based on the artificial intelligence model is improved.

Further, when the inference task of the artificial intelligence model corresponds to two operation sequences, to further improve the efficiency of executing the task inference based on the artificial intelligence model, the two operation sequences can be processed in parallel by two processing units in the present disclosure. FIG. 11 is a schematic time sequence diagram of two processing units processing two operation sequences in parallel according to some embodiments of the present disclosure.

As shown in FIG. 11, while processing unit 0 executes the operations in operation sequence 0, processing unit 1 also executes the operations in operation sequence 1. The process of processing unit 0 executing the operations in operation sequence 0 can be similar to the process of a single processing unit executing the operations in operation sequence 0 in FIG. 10. The process of processing unit 1 executing the operations in operation sequence 1 can also be similar to the process of the processing unit executing the operations in operation sequence 1 in FIG. 10, which is not repeated.

By comparing FIG. 10 and FIG. 11, executing the two operation sequences in parallel by two processing units further reduces the total time needed to execute the two operation sequences. Based on this, compared with the initial operation sequence corresponding to processing the inference task of the artificial intelligence model by a single processing unit in FIG. 8, the two processing units process the two operation sequences obtained by dividing the inference task of the artificial intelligence model in parallel. Not only the number of times for the processing unit accessing the DDR memory can be reduced, the consumed time for executing the task inference based on the artificial intelligence model can also be reduced. As shown in FIG. 11, the two processing units completing performing the two operation sequences only takes 12 clock cycles.

In FIGS. 8 to 11 above, to facilitate understanding of the advantages of dividing the inference task of the artificial intelligence model into the two operation sequences and the advantages of the processing unit reading the input data from the second memory, the target operations in the operation sequences that depend on the weight data and the process of reading the weight data corresponding to the target operations are not introduced.

The inference task of the artificial intelligence model can correspond to the at least two operation sequences. If a target operation that depends on the weight data exists in the operation sequence, when the processing unit executes the target operation in each operation sequence, the operation weight data of the target operation may need to be read from the first memory. Thus, the same target weight data may need to be repeatedly read multiple times from the first memory. Since the data reading efficiency is affected due to the bandwidth limitation between the first memory and the second memory, the performance of executing the inference task based on the artificial intelligence model can be further affected.

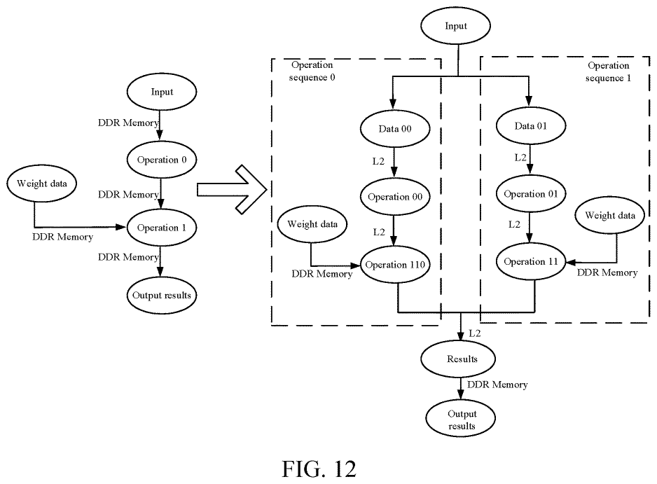

In some embodiments, a plurality of operation sequences can be scheduled to be executed by a plurality of different processing units. Since the target operations that depend on the weight data in the plurality of operation sequences are located at the same sequential position, when the plurality of processing units process the plurality of operation sequences in parallel, the plurality of processing units can read the same target weight data from the first memory simultaneously. The data reading pressure can be increased for the first memory to further increase the time needed for reading the weight data. FIG. 12 is a schematic diagram showing comparison between two implementation logics of performing an inference task based on an artificial intelligence model according to some embodiments of the present disclosure.

In FIG. 12, the left side of the arrow represents the implementation logic in which the inference task of the artificial intelligence model corresponds to one operation sequence. In the implementation logic, the operation sequence can still include operation 0 and operation 1. Meanwhile, assuming that operation 1 is the target operation that needs to depend on weight data, as shown in the implementation logic on the left side of the arrow, when executing operation 1, the processing unit can read the weight data from the DDR memory, and the computation processing corresponding to operation 1 can be performed.

As shown in the implementation logic diagram on the right side of the arrow in FIG. 12, after dividing the inference task of the artificial intelligence model into the two operation sequences, when executing operation 10 in operation sequence 0 and operation 11 in operation sequence 1, the weight data needs to be read from the DDR memory. Thus, the weight data may need to be read twice from the DDR memory, which increases the access burden of the DDR and also increases the time consumed for performing the task inference based on the artificial intelligence model.

Moreover, if operation sequence 0 and operation sequence 1 are executed in parallel by two processing units, the two processing units can simultaneously request the DDR memory to read the same weight data. The access pressure can be further increased for the DDR memory, and the time consumed for each processing unit to request the weight data is increased.

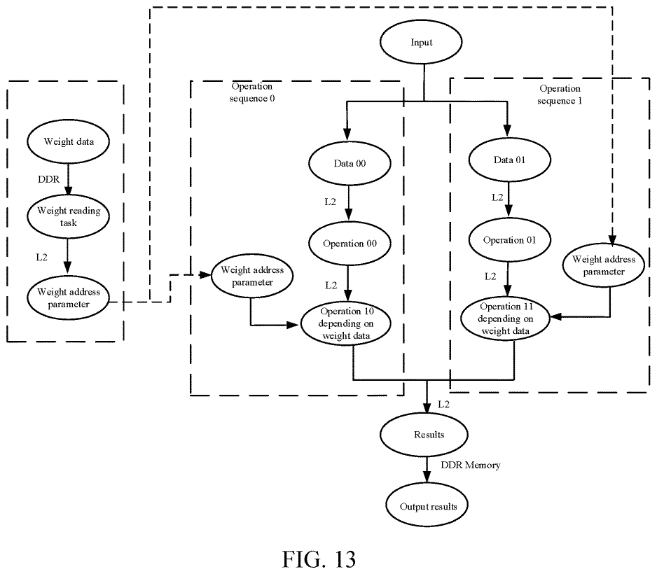

To reduce the number of times of repeatedly reading the same target weight data multiple times from the DDR memory, in the present disclosure, in the process of compiling the model file data of the artificial intelligence model, a process branch can be added for the target operations in the two operation sequences that depend on the weight data, as shown in FIG. 13. FIG. 13 is a schematic diagram showing an implementation logic of an operation control method according to some embodiments of the present disclosure.

In FIG. 13, assumed that the second operations in operation sequence 0 and operation sequence 1 are GEMM operations that depend on the same weight data. That is, operation 10 in operation sequence 0 and operation 11 in operation sequence 1 in FIG. 13 are both GEMM operations. Based on this, in the compilation stage of compiling the operation codes of operation sequence 0 and operation sequence 1, a weight reading task corresponding to operation 10 and operation 11 can be generated.

By comparing the two operation sequences on the right sides of the arrows of FIG. 13 and FIG. 12, a weight reading task associated with operation 10 and operation 11 is added in FIG. 13. By executing the weight reading task, the weight data corresponding to the GEMM operation can be read from the DDR memory and cached into the level-2 cache L2.

Moreover, an attribute parameter can be added in the weight reading task, operation 10, and operation 11. As shown in FIG. 13, the attribute parameter is a weight address parameter. The weight address parameter can include address information of a target data storage area allocated from the second memory and used for storing the weight data corresponding to the GEMM operation.

Based on FIG. 13, processing unit 0 and processing unit 1 are scheduled to process operation sequence 1 and operation sequence 2, respectively, and before processing unit 0 executes operation 10 and processing unit 1 executes operation 11, processing unit 2 is scheduled to execute the weight reading task, and the weight data read from the DDR memory is stored by processing unit 2 into the target data storage area of the level-2 cache L2.

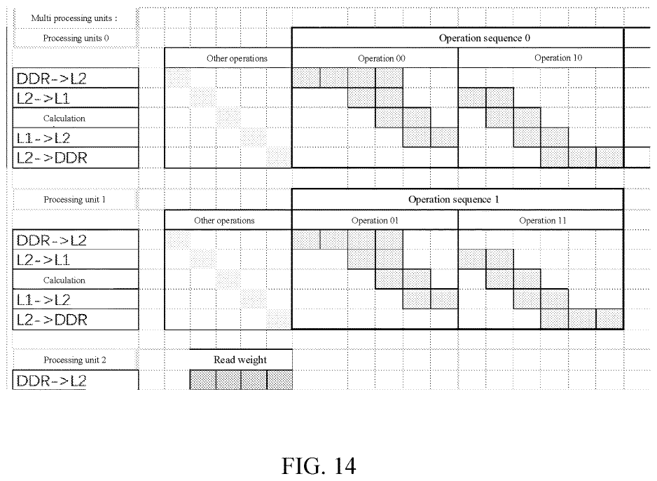

To facilitate understanding the advantage of scheduling processing unit 2 to execute the weight reading task before executing operation 10 and operation 11, an explanation is provided with reference to FIG. 14. FIG. 14 is a schematic time sequence diagram of scheduling a weight reading task and two operation sequences according to some embodiments of the present disclosure.

As shown in FIG. 14, before processing unit 0 and processing unit 1 execute the operations in the operation sequences, processing unit 2 is first scheduled to execute the weight reading task to read the weight data from the DDR memory into the level-2 cache L2. Based on this, when processing unit 0 executes operation 10 and processing unit 1 executes operation 11, the needed weight data can be read from the level-2 cache L2 without separately accessing the DDR memory to read the weight data. Thus, the situation of repeatedly reading the weight data from the DDR can be naturally reduced.

Corresponding to an operation control method of the present disclosure, the present disclosure further provides an operation control apparatus.

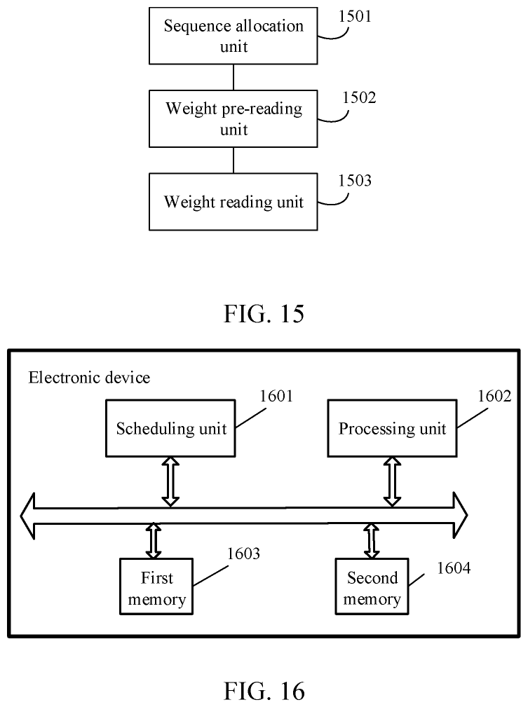

FIG. 15 is a schematic structural diagram of an operation control apparatus according to some embodiments of the present disclosure. The operation control apparatus includes a sequence allocation unit 1501, a weight pre-reading unit 1502, and a weight reading unit 1503.

The sequence allocation unit 1501 can be configured to determine a first processing unit configured to execute an operation sequence. The operation sequence can include at least one operation needed to be executed for processing an inference task based on an artificial intelligence model.

The weight pre-reading unit 1502 can be configured to, in response to a target operation that depends on the weight data existing in the operation sequence, before the first processing unit obtains the target weight data associated with the target operation, schedule a second processing unit to read the target weight data from a first memory and store the target weight data into a second memory. The first processing unit and the second processing unit can be connected to the second memory, and the data bandwidth between the second memory and the first processing unit and the data bandwidth between the second memory and the second processing unit are greater than the data bandwidth between the second memory and the first memory.

The weight reading unit 1503 can be configured to read the target weight data from the second memory based on the target operation when the first processing unit executes the operation sequence.

In some embodiments, the weight pre-reading unit can include a task scheduling subunit.

The task scheduling subunit can be configured to, in response to the target operation that depends on the weight data existing in the operation sequence, before the first processing unit obtains the target weight data associated with the target operation, determine the weight reading task associated with the target operation, and schedule the weight reading task to the second processing unit. The weight reading task can be configured to indicate reading the target weight data from the first memory.

In some embodiments, the operation control apparatus can further include a first scheduling unit or a second scheduling unit.

The first scheduling unit can be configured to sequentially schedule the operations in the operation sequence to the first processing unit.

Alternatively, the second scheduling unit can be configured to schedule the operation sequence to the first processing unit.

The weight pre-reading unit can include a first pre-reading subunit or a second pre-reading subunit.

The first pre-reading subunit can be configured to, in response to the target operation that depends on the weight data existing in the operation sequence, before scheduling the target operation to the first processing unit, schedule the second processing unit to read the target weight data associated with the target operation from the first memory and store the target weight data into the second memory.

Alternatively, the second pre-reading subunit can be configured to, in response to the target operation that depends on the weight data existing in the operation sequence, before the first processing unit executes the target operation, schedule the second processing unit to read the target weight data associated with the target operation from the first memory and store the target weight data into the second memory.

In some other embodiments, the weight pre-reading unit can include a state determination subunit and a scheduling subunit.

The state determination subunit can be configured to determine operating states of processing units in a processing unit.

The scheduling subunit can be configured to schedule the second processing unit in the processing unit set and having an operating state meeting requirements to read the target weight data from the first memory.

In some other embodiments, when the weight pre-reading unit stores the target weight data into the second memory, the weight pre-reading unit can be configured to store the target weight data into the target data storage area in the second memory. The target data storage area can be a storage area allocated to the target operation for storing the weight data when compiling the operation code corresponding to the target operation.

The weight reading unit can include a weight reading subunit.

The weight reading subunit can be configured to read the target weight data from the target data storage area based on the address information indicated by the target attribute parameter of the target operation. The target attribute parameter can be a parameter generated in the target operation for representing the target data storage area when compiling the operation code corresponding to the target operation and used to represent the target data storage area.

In some other embodiments, when the weight pre-reading unit stores the target weight data into the target data storage area in the second memory, the weight pre-reading unit can be configured to, in response to a maximum available storage capacity of the target data storage area being smaller than a data amount of the target weight data, divide the target weight data into at least two data blocks. A size of each data block can be smaller than or equal to the maximum available storage capacity. One data block of the at least two data blocks can be stored into the target data storage area each time.

The weight reading subunit can include a data block reading subunit.

The data block reading subunit can be configured to sequentially read the data blocks from the target data storage area based on the address information indicated by the target attribute parameter in the target operation when the first processing unit executes the target operation.

The operation control apparatus can further include a block continued storing unit.

The block continued storing unit can be configured to, after the first processing unit reads a data block from the target data storage area, sequentially store the data blocks among the at least two data blocks that have not been stored into the target data storage area into the target data storage area through the second processing unit.

In some other embodiments, the sequence allocation unit can include a sequence determination subunit, a sequence allocation subunit, and a weight pre-reading unit.

The sequence determination subunit can be configured to determine the at least two operation sequences needed to be executed to process the inference task by the artificial intelligence model. The operation sequence can include at least one operation having a sequential order. Operations located at the same sequential position in different operation sequences can correspond to the same operation type. However, the input data processed by different operation sequences can be different.

The sequence allocation subunit can be configured to determine, for each operation sequence, the first processing unit configured to execute the operation sequence.

In some other embodiments, the first processing units corresponding to different operation sequences determined by the sequence determination subunit can be different. The weight data of the target operations that depend on the weight data located at the same sequential position in different operation sequences can be the same.

The weight pre-reading unit can be configured to, in response to the target operation that depends on the weight data existing in the operation sequence, before the first processing units obtain the target weight data associated with the target operation, schedule the second processing unit to read the target weight data from the first memory and store the target weight data into the second memory.

Embodiments of the present disclosure further provide an electronic device. FIG. 16 is a schematic structural diagram of an electronic device according to some embodiments of the present disclosure. The electronic device at least includes a scheduling unit 1601, a plurality of processing units 1601, a first memory 1603, and a second memory 1604.

The processing units can be connected to the first memory, and the data bandwidth between the second memory and the processing units can be greater than the data bandwidth between the second memory and the first memory.

The scheduling unit can be configured to determine the first processing unit configured to execute the operation sequence. The operation sequence can include at least one operation needed to be executed for processing the inference task based on the artificial intelligence model, in response to the target operation that depends on the weight data existing in the operation sequence, before the first processing unit obtains the target weight data associated with the target operation, schedule a second processing unit to read the target weight data from the first memory and store the target weight data into the second memory.

The first processing unit can be configured to, when executing the operation sequence, read the target weight data from the second memory based on the target operation.

The first processing unit and the second processing unit can belong to the plurality of processing units.

For the specific operations of the scheduling unit, the first processing unit, and the second processing unit, reference can be made to the related descriptions above, which is not repeated here.

Certainly, the electronic device can further include a display unit and an input unit, etc., which are not specifically limited.

Embodiments of the present disclosure further provide a computer program product including computer-readable instructions that, when the computer-readable instructions are executed on the electronic device, cause the electronic device to implement any operation control method of embodiments of the present disclosure.

Embodiments of the present disclosure further provide a computer-readable storage medium carrying one or more computer programs that, when the one or more computer programs are executed by the electronic device, cause the electronic device to implement any operation control method of embodiments of the present disclosure.

In addition, the apparatus embodiments described above are merely illustrative. The units described as separate members may or may not be physically separated, and the members displayed as units may or may not be physical units. That is, the units may be located in one place or distributed to multiple network units. Some or all of the modules may be selected according to actual needs to achieve the objectives of the solutions of embodiments of the present disclosure. In addition, in the accompanying drawings of the apparatus embodiments provided in the present disclosure, the connection relationships between the modules can indicate that communication connections among them, which can be implemented as one or more communication buses or signal lines.

Through the description of the above embodiments, those skilled in the art can understand that the present disclosure can be implemented by means of software together with necessary general hardware, and of course, may also be implemented through dedicated hardware, e.g., dedicated integrated circuits, dedicated CPUs, dedicated memories, dedicated components, etc. In general, any function completed by computer programs can easily be implemented by corresponding hardware, and the specific hardware structures configured to implement the same function can be various, such as analog circuits, digital circuits, or dedicated circuits. However, for the present disclosure, implementation by software programs can be a better embodiment. Based on such understanding, the technical solutions of the present disclosure, essentially or the part that contributes to the existing technology, can be implemented in the form of a software product. The computer software product can be stored in a readable storage medium, such as a computer floppy disk, USB flash drive, removable hard disk, ROM, RAM, magnetic disk, or optical disk, etc., and include several instructions used to cause a computer device (e.g., a personal computer, a training device, or a network device) to execute the methods described in embodiments of the present disclosure.

Embodiments of the present disclosure can be realized wholly or partially by software, hardware, firmware, or a combination thereof. When being implemented by software, embodiments of the present disclosure can be implemented wholly or partially in the form of a computer program product.

The computer program product can include one or more computer instructions. When the computer program instructions are loaded and executed on a computer, processes or functions according to embodiments of the present disclosure can be wholly or partially generated. The computer can be a general-purpose computer, a special-purpose computer, a computer network, or another programmable apparatus. The computer instructions can be stored in a computer-readable storage medium or transmitted from one computer-readable storage medium to another computer-readable storage medium. For example, the computer instructions can be transmitted from one website, computer, training device, or data center to another website, computer, training device, or data center through wired means (e.g., coaxial cable, optical fiber, or digital subscriber line (DSL)) or wireless means (e.g., infrared, wireless, microwave, etc.). The computer-readable storage medium can be any available medium that can be stored by a computer, or a data storage device such as a training device or a data center that integrates one or more available media. The available medium can be a magnetic medium (e.g., a floppy disk, a hard disk, or magnetic tape), an optical medium (e.g., DVD), or a semiconductor medium (e.g., a solid state disk (SSD)).

What is claimed is:

1. An operation control method comprising:
determining a first processing unit for executing an operation sequence that includes at least one operation needed to be executed for processing an inference task based on an artificial intelligence model;
in response to the operation sequence including a target operation that depends on weight data, before the first processing unit obtains target weight data associated with the target operation, scheduling a second processing unit to read the target weight data from a first memory and storing the target weight data into a second memory, the first processing unit and the second processing unit being connected to the second memory, and a data bandwidth between the second memory and the first processing unit and a data bandwidth between the second memory and the second processing unit being greater than a data bandwidth between the second memory and the first memory; and
during a process of the first processing unit executing the operation sequence, reading the target weight data from the second memory based on the target operation.

2. The operation control method according to claim 1, wherein scheduling the second processing unit to read the target weight data from the first memory includes:
determining a weight reading task associated with the target operation and indicating reading the target weight data from the first memory; and
scheduling the weight reading task to the second processing unit.

3. The operation control method according to claim 1, further comprising:
sequentially scheduling operations in the operation sequence to the first processing unit or scheduling the operation sequence to the first processing unit;
wherein scheduling the second processing unit to read the target weight data from the first memory before the first processing unit obtains the target weight data includes scheduling the second processing unit to read the target weight data from the first memory before the target operation is scheduled to the first processing unit or before the first processing unit executes the target operation.

4. The operation control method according to claim 1, wherein scheduling the second processing unit to read the target weight data from the first memory includes:
determining operating states of processing units in a processing unit set; and
scheduling the second processing unit, in the processing unit set and having an operating state meeting requirements, to read the target weight data from the first memory.

5. The operation control method according to claim 1, wherein:
storing the target weight data into the second memory includes:
storing the target weight data into a target data storage area in the second memory, the target data storage area being allocated for the target operation for storing weight data during a process of compiling operation code corresponding to the target operation; and
reading the target weight data from the second memory based on the target operation includes:
reading the target weight data from the target data storage area based on address information indicated by a target attribute parameter in the target operation, the target attribute parameter being generated for the target operation for representing the target data storage area during the process of compiling the operation code.

6. The operation control method according to claim 5, wherein:
storing the target weight data into the target data storage area in the second memory includes:
in response to a maximum available storage capacity of the target data storage area being smaller than a data amount of the target weight data, dividing the target weight data into at least two data blocks each having a size smaller than or equal to the maximum available storage capacity; and
storing one data block of the at least two data blocks into the target data storage area each time; and
reading the target weight data from the target data storage area based on the address information includes:
during a process of the first processing unit executing the target operation, sequentially reading data blocks from the target data storage area based on the address information;
the operation control method further comprising:
after the first processing unit reads a data block from the target data storage area, sequentially storing, through the second processing unit, data blocks of the at least two data blocks that have not been stored into the target data storage area into the target data storage area.

7. The operation control method according to claim 1, wherein determining the first processing unit for executing the operation sequence includes:
determining at least two operation sequences needed to be executed for processing the inference task by the artificial intelligence model, each operation sequence including at least one operation in a sequential order, operations located at a same sequential position in different operation sequences corresponding to a same operation type, and input data processed by different operation sequences being different; and
for each operation sequence, determining the first processing unit configured to execute the operation sequence.

8. The operation control method according to claim 7, wherein:
first processing units corresponding to different operation sequences are different;
target operations located at a same sequential position in different operation sequences depend on same weight data; and
scheduling the second processing unit to read the target weight data from the first memory and store the target weight data into the second memory before the first processing unit obtains the target weight data includes:
before the first processing units obtain the target weight data associated with the target operation, scheduling the second processing unit to read the target weight data from the first memory and storing the target weight data into the second memory.

9. An electronic device comprising:
one or more processors; and
one or more memories storing a computer program that, when executed by the one or more processors, causes the electronic device to:
determine a first processing unit for executing an operation sequence that includes at least one operation needed to be executed for processing an inference task based on an artificial intelligence model;
in response to the operation sequence including a target operation that depends on weight data, before the first processing unit obtains target weight data associated with the target operation, schedule a second processing unit to read the target weight data from a first memory and storing the target weight data into a second memory, the first processing unit and the second processing unit being connected to the second memory, and a data bandwidth between the second memory and the first processing unit and a data bandwidth between the second memory and the second processing unit being greater than a data bandwidth between the second memory and the first memory; and
during a process of the first processing unit executing the operation sequence, read the target weight data from the second memory based on the target operation.

10. The electronic device according to claim 9, wherein the computer program, when executed by the one or more processors, further causes the electronic device to, when scheduling the second processing unit to read the target weight data from the first memory:
determine a weight reading task associated with the target operation and indicating reading the target weight data from the first memory; and
schedule the weight reading task to the second processing unit.

11. The electronic device according to claim 9, wherein the computer program, when executed by the one or more processors, further causes the electronic device to:
sequentially schedule operations in the operation sequence to the first processing unit or scheduling the operation sequence to the first processing unit; and
schedule the second processing unit to read the target weight data from the first memory before the target operation is scheduled to the first processing unit or before the first processing unit executes the target operation.

12. The electronic device according to claim 9, wherein the computer program, when executed by the one or more processors, further causes the electronic device to, when scheduling the second processing unit to read the target weight data from the first memory:
determine operating states of processing units in a processing unit set; and
schedule the second processing unit, in the processing unit set and having an operating state meeting requirements, to read the target weight data from the first memory.

13. The electronic device according to claim 9, wherein the computer program, when executed by the one or more processors, further causes the electronic device to:
store the target weight data into a target data storage area in the second memory, the target data storage area being allocated for the target operation for storing weight data during a process of compiling operation code corresponding to the target operation; and
read the target weight data from the target data storage area based on address information indicated by a target attribute parameter in the target operation, the target attribute parameter being generated for the target operation for representing the target data storage area during the process of compiling the operation code.

14. The electronic device according to claim 13, wherein the computer program, when executed by the one or more processors, further causes the electronic device to:
when storing the target weight data into the target data storage area in the second memory:
in response to a maximum available storage capacity of the target data storage area being smaller than a data amount of the target weight data, divide the target weight data into at least two data blocks each having a size smaller than or equal to the maximum available storage capacity; and
store one data block of the at least two data blocks into the target data storage area each time;
when reading the target weight data from the target data storage area based on the address information:
during a process of the first processing unit executing the target operation, sequentially read data blocks from the target data storage area based on the address information; and
after the first processing unit reads a data block from the target data storage area, sequentially store, through the second processing unit, data blocks of the at least two data blocks that have not been stored into the target data storage area into the target data storage area.

15. The electronic device according to claim 9, wherein the computer program, when executed by the one or more processors, further causes the electronic device to, when determining the first processing unit for executing the operation sequence:
determine at least two operation sequences needed to be executed for processing the inference task by the artificial intelligence model, each operation sequence including at least one operation in a sequential order, operations located at a same sequential position in different operation sequences corresponding to a same operation type, and input data processed by different operation sequences being different; and
for each operation sequence, determine the first processing unit configured to execute the operation sequence.

16. The electronic device according to claim 15, wherein:
first processing units corresponding to different operation sequences are different;
target operations located at a same sequential position in different operation sequences depend on same weight data; and
the computer program, when executed by the one or more processors, further causes the electronic device to, when scheduling the second processing unit to read the target weight data from the first memory and store the target weight data into the second memory before the first processing unit obtains the target weight data:
before the first processing units obtain the target weight data associated with the target operation, schedule the second processing unit to read the target weight data from the first memory and store the target weight data into the second memory.

17. A non-transitory computer-readable storage medium storing a computer program that, when executed by one or more processors, causes an electronic device including the one or more processors to:
determine a first processing unit for executing an operation sequence that includes at least one operation needed to be executed for processing an inference task based on an artificial intelligence model;
in response to the operation sequence including a target operation that depends on weight data, before the first processing unit obtains target weight data associated with the target operation, schedule a second processing unit to read the target weight data from a first memory and storing the target weight data into a second memory, the first processing unit and the second processing unit being connected to the second memory, and a data bandwidth between the second memory and the first processing unit and a data bandwidth between the second memory and the second processing unit being greater than a data bandwidth between the second memory and the first memory; and
during a process of the first processing unit executing the operation sequence, read the target weight data from the second memory based on the target operation.

18. The storage medium according to claim 17, wherein the computer program, when executed by the one or more processors, further causes the electronic device to, when scheduling the second processing unit to read the target weight data from the first memory:
determine a weight reading task associated with the target operation and indicating reading the target weight data from the first memory; and
schedule the weight reading task to the second processing unit.

19. The storage medium according to claim 17, wherein the computer program, when executed by the one or more processors, further causes the electronic device to:
sequentially schedule operations in the operation sequence to the first processing unit or scheduling the operation sequence to the first processing unit; and
schedule the second processing unit to read the target weight data from the first memory before the target operation is scheduled to the first processing unit or before the first processing unit executes the target operation.

20. The storage medium according to claim 17, wherein the computer program, when executed by the one or more processors, further causes the electronic device to, when scheduling the second processing unit to read the target weight data from the first memory:
determine operating states of processing units in a processing unit set; and
schedule the second processing unit, in the processing unit set and having an operating state meeting requirements, to read the target weight data from the first memory.
